(19) United States
(12) Patent Application Publication
(10) Pub. No.: US 2008/0267024 A1
(43) Pub. Date: Oct. 30, 2008

(54) Optical Storage System Method for Improving Reliability Thereof

(75) Inventor: Bruno Verschaeve, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,838

(22) PCT Filed: Sep. 12, 2006
(86) PCT No.: PCT/IB06/53234

§ 371 Date: Mar. 24, 2008

(30) Foreign Application Priority Data
Sep. 22, 2005 (EP) 05108768.2

(51) Int. Cl. G11B 7/00

(52) U.S. Cl. 369/44.32

(57) ABSTRACT

A method and system for improving reliability in an optical storage system (100) is disclosed. A time shift measurement between two streams of information (150, 151) is performed during a writing operation of said optical storage system (100) to an optical storage medium (101), such as a CD, DVD or BluRay Disc (BD). Writing operation of the optical storage system is interrupted when the time shift measurement is greater than a predetermined level for detecting an irregularity in said optical storage system (100) during said writing operation, e.g. caused by a tangential shock, vibration, eccentricity or unbalance of the optical storage medium (101). Thus the irregularity, causing a faulty writing operation, the optical storage system (100) is quickly detected in order to prevent wasting a disc by interrupting recording as soon as a shock, vibration, etc. is detected by means of the measurement.

This invention pertains in general to the field of optical storage systems. More particularly the invention relates to an optical storage system having improved reliability by at least partly interrupting a writing operation of the optical storage system when an irregularity of said writing operation is detected in said optical storage system during the writing operation to an optical storage medium, e.g. caused by tangential shock or vibrations, as well as a method for providing the improved reliability.

Different formats of optical recording medium including read-only optical discs, such as CD (Compact Disk), and DVD (Digital Versatile Disc); and recordable optical discs such as a CD-R (Compact Disc-Recordable), CD-RW (Compact Disc-Rewritable) and DVD+RW (Digital Versatile Disc+Rewritable); and Blu-ray discs (BD) are well known. These optical recording medium media may be written and/or read out by means of an optical pick up unit or a read head in an optical scanning device. The optical pick up units are mounted on a linear bearing for radially scanning across the tracks of the optical disc. The read head may comprise, among other elements, an actuator for focus, radial and tilt.

The optical scanning device comprises a light source such as a laser, which is directed toward the optical disc. In addition to detecting and reading the information from the optical disc, the optical pick up unit also detects a variety of error signals, e.g., focus error, radial error and tracking error. These error signals are used by the optical scanning device to adjust various aspects of the scanning procedure to help reduce these errors. For example, the focus error signal can be used to determine how much the focus actuator should be steered to improve the focus of the laser.

As mentioned above, off track detection used in optical disc systems is based on radial and focus servo signals. The radial and focus servo signals give, although very slowly, an indication that the laser spot is getting off-track in radial direction (radial signal) or out-of-focus in vertical direction (focus signal). In case of a shock or vibration in the same direction as the track, called the tangential direction, detection with these servo signals is difficult or not possible at all. As a result, the shock or vibration will cause the optical disc system to write data in the wrong spot on the disc. The same problem arises when the optical disc shows an eccentricity or unbalance leading to data written to the disc at the wrong position. Known measurement methods are for instance too slow to measure fast changes in the position of recorded data as occurring with discs having eccentricity or unbalance. Thus, the optical disc system writes data in the wrong spot on the disc when this shows too much eccentricity or unbalance, and the recorded disc has to be wasted.

Thus, there is a need for an advantageous method and apparatus having increased reliability, e.g. by quickly detecting tangential shock or vibration in an optical storage system, or an eccentricity or unbalance of an optical storage medium in an optical storage system, e.g. in order to prevent wasting a disc by interrupting recording as soon as a shock or vibration is detected in tangential direction, or as soon as an eccentricity or unbalance of the optical storage medium is detected, during writing to the optical storage medium.

Accordingly, the present invention preferably seeks to mitigate, alleviate or eliminate one or more of the above-identified deficiencies in the art and disadvantages singly or in any combination and solves at least the above mentioned problems by providing a system, a method, and a computer-readable medium for detecting an irregularity during a writing operation of an optical storage system, e.g. caused by shock, vibrations, eccentricity, or unbalance in the optical storage system according to the appended patent claims.

The solution according to an embodiment of the invention is based on the insight to use time shift measurements to determine that e.g. tangential shock, vibration, eccentricity, or unbalance has occurred and to interrupt the operation of the optical storage system when such irregularities are determined by the time shift measurements. According to one aspect of the invention, a method for improving reliability of an optical storage system is provided. The method comprises: performing a time shift measurement between two streams of information during a writing operation of said optical storage system to determined positions of a track of an optical storage medium of said optical storage system; and at least partly interrupting the writing operation of the optical storage system when the time shift measurement is greater than a predetermined level for detecting a irregularity of said writing operation, with regard to the determined positions of the track, in said optical storage system during said writing operation. According to one embodiment, the irregularity is a deviation of said writing operation, with regard to the determined positions of the track, caused by a tangential shock in said optical storage system. According to another embodiment, the irregularity is a deviation of said writing operation, with regard to the determined positions of the track, caused by an eccentricity or unbalance of said optical storage medium in said optical storage system.

According to another aspect of the invention, an optical storage system having improved reliability is disclosed. The system comprises means for performing a time shift measurement between two streams of information provided during a writing operation of the optical storage system to determined positions of a track of an optical storage medium of the optical storage system; and means for at least partly interrupting the writing operation of the optical storage system when the time shift measurement is greater than a predetermined level, configured for detecting an irregularity of said writing operation, with regard to the determined positions of the track, in said optical storage system during said writing operation.

According to a further aspect of the invention, a computer-readable medium is provided having embodied thereon a computer program for improving reliability in an optical storage system. The computer program comprises a first code segment for performing a time shift measurement between two streams of information provided during a writing operation to determined positions of a track of an optical storage medium of said optical storage system; and a second code segment for at least partly interrupting the writing operation of the optical storage system when the time shift measurement is greater than a predetermined level, configured for detecting an irregularity of said writing operation, with regard to the determined positions of the track, in said optical storage system during said writing operation.

The present invention has the advantage over the prior art that it quickly detects irregularities of a writing operation in optical storage systems, e.g. caused by tangential shock or vibrations, eccentricity of an optical storage medium or unbalance of the system, and allows the system to stop writing operations during such irregularities.

These and other aspects, features and advantages of which the invention is capable of will be apparent and elucidated from the following description of embodiments of the present invention, reference being made to the accompanying drawings, in which

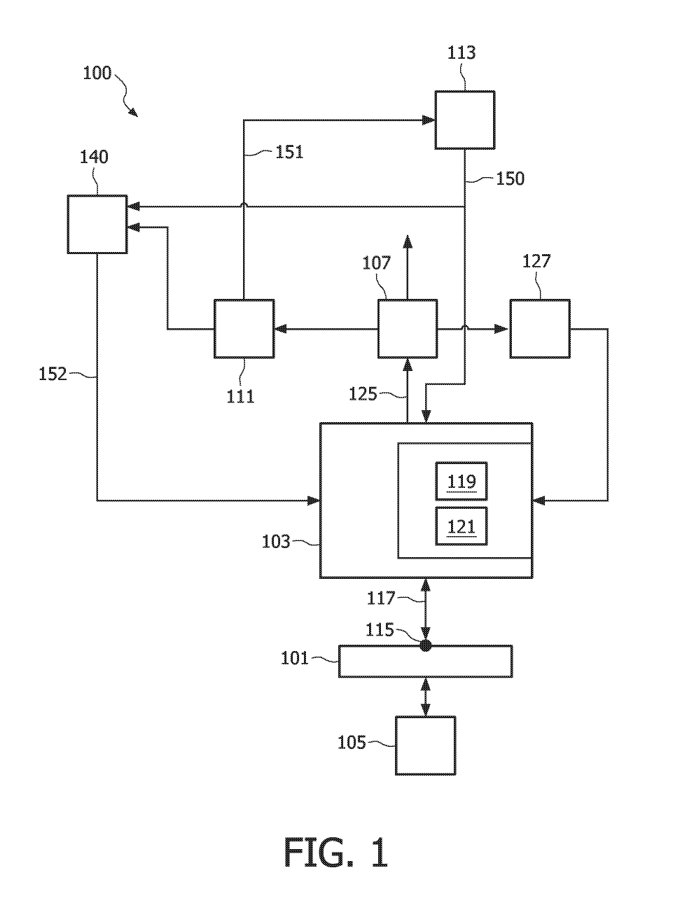

FIG. 1 is a block diagram of an optical system upon which the invention may be implemented;

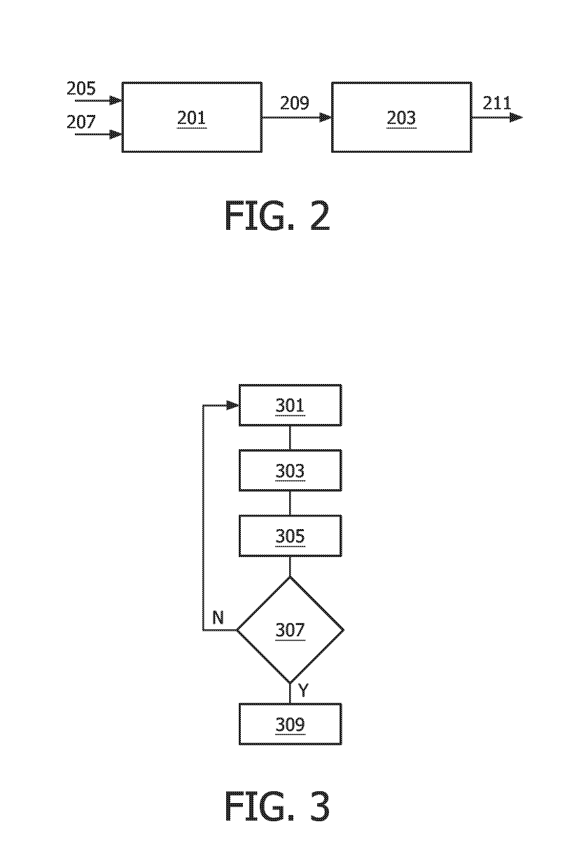

FIG. 2 is a block diagram of tangential vibration detection unit for a CD or DVD system according to one embodiment of the invention;

FIG. 3 is a flow chart illustrating the operation of the tangential vibration detection unit illustrated in FIG. 2 according to one embodiment of the invention;

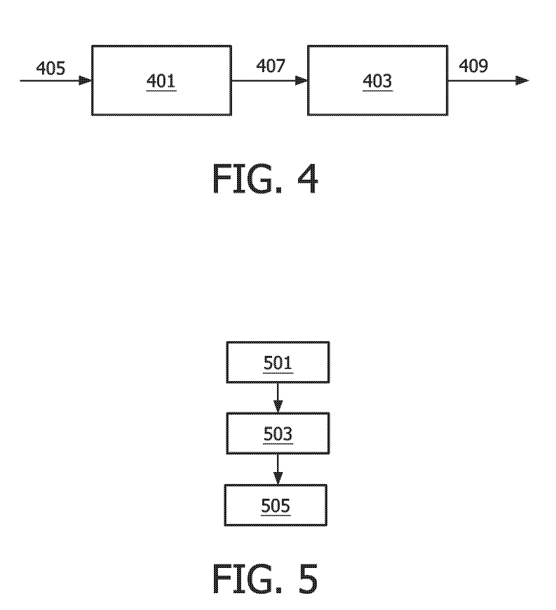

FIG. 4 is a block diagram of tangential vibration detection unit for a BD system according to one embodiment of the invention;

FIG. 5 is a flow chart illustrating the operation of the tangential vibration detection unit illustrated in FIG. 4 according to one embodiment of the invention;

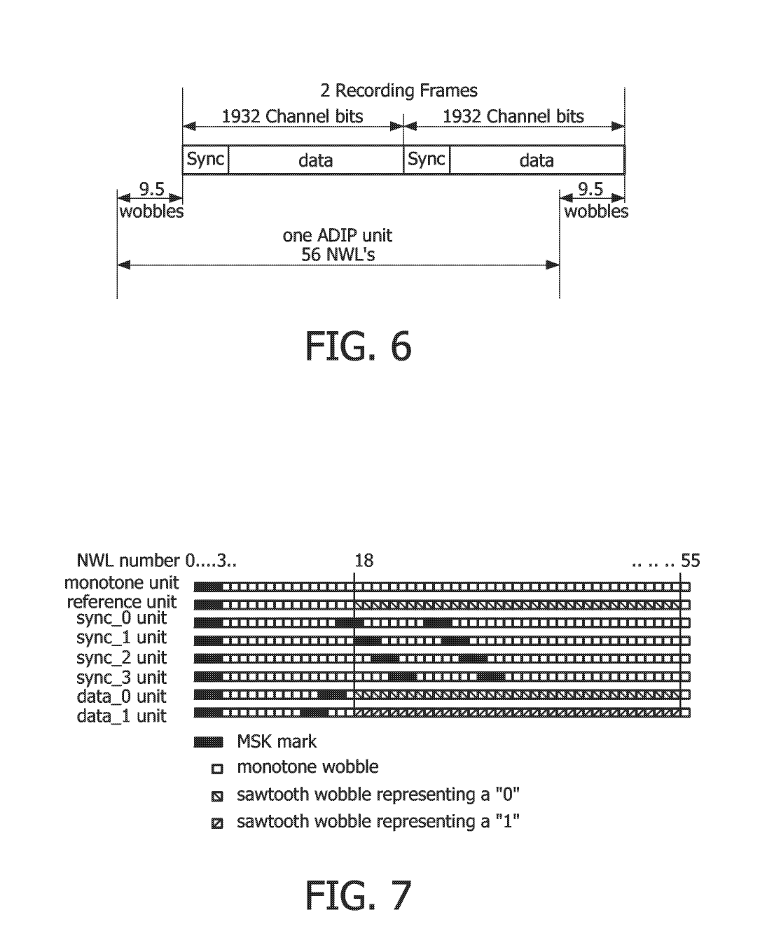

FIG. 6 is a timing chart illustrating the wobble sync and data sync according to one embodiment of the invention;

FIG. 7 is timing chart according to one embodiment of the invention;

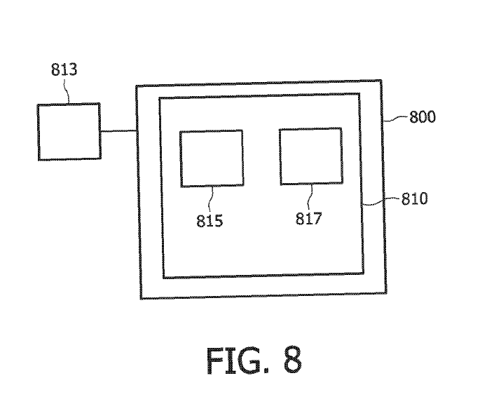

FIG. 8 is a computer readable medium according to one embodiment of the invention.

The following description focuses on exemplary embodiments of the present invention applicable to detection of tangential shock or eccentricity in an optical disc system. However, it will be appreciated that the invention is not limited to this application but may be applied to any storage application with pre-recorded position information with a requirement on the accuracy of the location of the recorded data relative to the position information. Also, other embodiments may use different optical storage media having at least one substantial concentric information track, but a contour shape differing from that of a circular disc, e.g. business card shaped optical storage media, etc. Further, different causes for the irregularities implying a deviation from writing to a predetermined position of such a track, other than the mentioned tangential shock, vibration, eccentricity or unbalance may be envisaged by the skilled person.

FIG. 1 illustrates an optical writing system upon which the invention may be implemented. The optical system 100 is arranged to write information to a disc 101. The system may additionally also be used to read information from pre-recorded discs, such as disc 101. The system 100 is provided with an optical pick-up unit (OPU) 103 for scanning a track on the disc 101 and write control means comprising drive means 105 for rotating the disc 101, such as a spindle motor configured to rotate disc 101 around an axle continuously rotating in use thereof at varying rotational speed. Further, system 100 comprises a reading unit 107 for example comprising a channel decoder and an error corrector, and tracking means 127. The OPU 103 is also connected to a writing unit 113. The writing unit 113 provides recording data 150 to the OPU for writing to disc 101 during writing operation of system 100. Further, the writing unit 113 receives disc speed information 151 from disc position information extraction unit 111 in order to control data flow of recording data 150 to the OPU 103. The OPU 103 comprises an optical system of a known type for generating a radiation spot 115 focused on a track of a recording layer of the disc 101 via a radiation beam 117 guided through optical elements. The radiation beam 117 is generated by a radiation source, e.g. a laser diode. The reading head further comprises an actuator 118 which comprises a focusing actuator coil 119 for focusing the radiation beam 117 on the disc 101 and a radial actuator coil 121 for fine positioning of the spot 115 in radial direction on the center of the track. The radiation reflected by the recording layer, to which radiation beam 117 is focused, is detected by a radiation detector of a usual type for generating detector signal 125 including a read signal, a tracking error and a focus error. The apparatus also comprises a time shift measurement unit 140, which is connected to a disc position information extraction unit 111 and to writing unit 113. The time shift measurement unit 140 will be described in more detail below.

The apparatus 100 is provided with tracking means 127 coupled to the read head 103 for receiving the tracking error and controlling the radial actuators. The read signal is converted into output information in the reading unit 107. In many optical storage media, such as in CD-R, CD-RW, DVD-R/+R/-RW/+RW, DVD-RAM, and Blu-ray disc systems, a wobble track is used in which the recording track is meandered. The address information and the synchronization signal are recorded on the wobble. For example, the rewritable lead-in, data and lead out zones contain wobble-shaped grooves, such that the data recorded in these zones is aligned and recorded in the wobble-shaped grooves. ADIP (Address In Pre-groove) information composed of an ADIP address and AUX data is modulated in the wobbled grooves. The ADIP address comprises physical ADIP address information in all the zones containing the wobbled grooves. A synchronization signal may also be obtained from the wobble signal, which will be used below to determine when a tangential shock or vibration has occurred.

According to one embodiment of the invention, the invention is incorporated in a CD and/or DVD optical disc system, the operation of which will be described with reference to FIGS. 2-3. In this embodiment, the time shift measurement unit 140 comprises a calculation unit 201 and an interrupt signal generator 203. Alternatively, the interrupt signal generator may be incorporated into the calculation unit 201. In step 301, the calculation unit 201 receives the disc position information 205. In step 303, the calculation unit 201 receives the recording data 207, which in FIG. 1 is illustrated at 150. The calculation unit 201 then calculates a time shift measurement for the time difference between the disc position information 205 read from disc (from the wobble on the disc) and the recording data 207 in step 305. Since this measurement is possible in real-time, it is possible to detect when the disc and the read/write head shift in relative position to each other due to shock or a vibration. This relative shift in position causes a steep increase of the time shift measurement value. If it is determined in step 307 that the time shift measurement value is greater than a predetermined threshold limit, the calculation unit 210 sends a panic signal 209 (shown at 152 in FIG. 1) to the interrupt signal generator 203, which generates an interrupt signal 211 in step 309. In response to the interrupt signal, the current writing operation of the disc system is interrupted. For example, the laser power of OPU 103 may be switched from write power to read power, or the laser power may be turned off completely and writing operation of system 100 may thus be aborted completely in order to be resumed at a later point in time. As a result, the amount of data that is incorrectly recorded is reduced to a minimum.

After an interrupt, recording may begin again for instance after a certain time delay. According to one embodiment, the system 100 may check during a test period if stable read-out from disc 101 is possible. If this is the case, vibrations or shock that caused the panic stop have probably ceased and the system may re-start recording. When a new write cycle is initiated, the above-described method is re-initiated in order to check if stable writing to the disc is possible. For example, a seam-less link operation can be performed so as to continue recording exactly where the recording stopped. Seam-less link recording is a system feature that appends data to already recorded data without a seam. For this feature, the control unit 111 starts and stops the recording operation on the information from the recorded data instead of the wobble.

According to one embodiment of the invention, the invention is incorporated in a BluRay disc (BD) optical disc system, the operation of which will be described with reference to FIGS. 4-7. In this embodiment, the time shift measurement unit 140 comprises a phase locked-loop unit (PLL) 401 and an interrupt signal generator 403. Alternatively, the interrupt signal generator 403 may be incorporated into the PLL 401. A write clock signal may be derived from the wobble on the disc by the PLL 401. In step 501, the PLL 401 measures the timing of the sync signal in the wobble. For example, the calculation unit measures the time difference between the wobble sync and the data sync as illustrated in FIGS. 6-7. In FIG. 6, the position of the recorded data sync is relative to the ADIP (wobble). FIG. 7 shows an example of how sync information is stored on a BD.

In case of eccentricity or unbalance, the wobble fluctuates and makes write clock generation more difficult. At a certain level of fluctuation, the bandwidth of the write clock generation will not be sufficient. At this point, the position of the data relative to the wobble will be out of specification. According to this embodiment of the invention, the PLL 401 signals 407 the interrupt signal generator 403 to generate an interrupt signal 409 before the data relative to the wobble is out of specification in step 503. When the control unit 111 receives the interrupt signal, the control unit either stops or slows the writing operation of the BD system in step 505.

As illustrated above, a programmable trigger level in combination with an interrupt can warn the system of upcoming or effective out of specification conditions during writing operations. The invention may also be used for additional system analysis. During development, the measurement may be used to validate and tune the bandwidth of the write clock generator. From a recorded disc, the system may check if the recorded data location relative to the wobble is within a predetermined specification, e.g. the Blu-ray specification. Furthermore, it is possible to use the time shift measurement to accommodate the write clock generation in order to react on write-speed variation conditions.

In another embodiment of the invention according to FIG. 8, a computer-readable medium is illustrated schematically. A computer-readable medium 800 has embodied thereon a computer program 810 for processing by a computer 813, the computer program comprising code segments for increasing a dynamic voltage swing in an actuator system. The computer program comprises a code segment 815 for performing a time shift measurement of information on a disc; and a code segment 816 for generating an interrupt signal for interrupting the operation of the disc system when the time shift is greater than a predetermined level.

The invention may be implemented in any suitable form including hardware, software, firmware or any combination of these. The invention may be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different systems than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for improving reliability of an optical storage system (100), comprising
performing a time shift measurement between two streams of information during a writing operation of said optical storage system (100) to determined positions of a track of an optical storage medium (101) of said optical storage system (100); and
at least partly interrupting the writing operation of the optical storage system when the time shift measurement is greater than a predetermined level for detecting an irregularity of said writing operation, with regard to the determined positions of the track, in said optical storage system (100) during said writing operation.

2. The method according to claim 1, wherein said performing the time shift measurement comprises:
determining time of position information on the optical storage medium;
determining time of recording data;
determining a time shift difference between said time of position information and said time of recording data as said time shift measurement.

3. The method according to claim 2, comprising determining said position information from a wobble track on the optical storage medium.

4. The method according to claim 1, wherein said performing the time shift measurement comprises:
determining timing of a wobble sync;
determining timing of a data sync;
determining time shift difference between said wobble sync and said data sync.

5. The method according to claim 4, comprising reading the wobble sync from a wobble track on said optical storage medium.

6. The method according to claim 1, wherein said performing the time shift measurement comprises:
generating a clock signal from wobble sync data recorded on the optical storage medium; and
generating an interrupt signal when the timing of the wobble sync data fluctuates at a greater rate than a predetermined value for said interrupting of the writing operation.

7. The method according to claim 1, wherein said interrupting of writing operation comprises changing laser power of the optical storage system from write power to read power.

8. The method according to claim 1, further comprising:
starting a reading operation from said optical storage medium after said interrupting of writing operation of said optical storage system;
determining if said reading operation is stable; and
resuming writing operation of said optical storage system when said reading operation is determined being stable.

9. The method according to claim 8, further comprising:
resuming writing operation of said optical storage system after a pre-determined time delay, when said reading operation is determined being stable.

10. The method according to claim 8, comprising beginning seam-less link recording of said optical storage medium (101) once the writing operation of the optical storage system (100) resumes.

11. The method according to claim 1, wherein said at least partly interrupting the writing operation comprises reducing recording speed during said writing operation.

12. The method according to claim 1, wherein said irregularity is a deviation of said writing operation, with regard to the determined positions of the track, caused by a tangential shock or vibration in said optical storage system (100).

13. The method according to claim 1, wherein said irregularity is a deviation of said writing operation, with regard to the determined positions of the track, caused by an eccentricity or unbalance of said optical storage medium (101) in said optical storage system (100).

14. The method according to claim 1, wherein said optical storage system is a CD, DVD or BluRay system, and said optical storage medium is an optical disc including CD, DVD or BluRay Disc (BD), respectively.

15. An optical storage system (100) having improved reliability comprising
means (140) for performing a time shift measurement between two streams of information (150, 151) provided during a writing operation of said optical storage system (100) to determined positions of a track of an optical storage medium (101) of said optical storage system (100); and
means for at least partly interrupting the writing operation of the optical storage system when the time shift measurement is greater than a predetermined level, configured for detecting an irregularity of said writing operation, with regard to the determined positions of the track, in said optical storage system (100) during said writing operation.

16. The system according to claim 15, wherein said means for performing the time shift measurement comprises:
means for determining time of optical storage medium position information on the optical storage medium;
means for determining time of recording data;
means for determining time shift difference between said optical storage medium position information and said recorded data.

17. The system according to claim 15, wherein said means for performing the time shift measurement comprises:
means for determining timing of wobble sync;
means for determining timing of data sync;
means for determining time shift difference between said wobble sync and said data sync.

18. The system according to claim 15, wherein said means for performing the time shift measurement comprises:
means for generating a clock signal from wobble sync data on the optical storage medium;
means for generating an interrupt signal for said interrupting the writing operation of the optical storage system when the timing of the wobble sync data fluctuates at a greater rate than a predetermined value.

19. A computer-readable medium (800) having embodied thereon a computer program for improving reliability in an optical storage system (100), comprising
a first code segment for performing a time shift measurement between two streams of information (150, 151) provided during a writing operation to determined positions of a track of an optical storage medium (101) of said optical storage system (100); and
a second code segment for at least partly interrupting the writing operation of the optical storage system when the time shift measurement is greater than a predetermined level, configured for detecting an irregularity of said writing operation, with regard to the determined positions of the track, in said optical storage system (100) during said writing operation.
